(19) United States
(12) Patent Application Publication
(10) Pub. No.: US 2017/0139891 A1
(43) Pub. Date: May 18, 2017

(54) SHARED ELEMENTS FOR BUSINESS INFORMATION DOCUMENTS

(71) Applicant: SAP SE, Walldorf (DE)

(72) Inventors: Christian AH-SOON, Carrières-sur-Seine (FR); Didier GROS, Lyon (FR); Bogdan RADULESCU, Paris (FR); Stephane MONTAGNON, Lyon (FR); Anthony MULLER, Paris (FR); Tin Jean-Paul NGUYEN, Asnières-sur-Seine (FR); Alexis GUE, Paris (FR)

(21) Appl. No.: 14/941,010

(22) Filed: Nov. 13, 2015

(51) Int. Cl. G06F 17/24; G06F 17/30

(52) U.S. Cl. CPC G06F 17/246; G06F 17/30533

(57) ABSTRACT

Information defining a first business information document, including a report element having a data provider and a variable, is received from a first user's device. The first document is saved in a central management system repository as a shared element, the shared element in the repository including an indication of the data provider and an indication of the variable. A request to access the shared element in the repository is then received from a second user's device. The shared element in the repository, including the indication of the data provider and the indication of the variable, are then incorporated within a second document for the second user. The shared element in the second document may be linked to the shared element in the repository such that a change to the shared element in the repository propagates to the shared element in the second document.

### BACKGROUND

Enterprise software systems may receive, generate and store data related to many aspects of a business. These systems may provide reporting, planning, and/or analysis of the data based on logical entities such as dimensions and measures. Dimensions may represent, for example, sets of values (i.e., members) along which an analysis may be performed and/or a report may be generated (e.g., Country, Year, Product), and measures may be indicators, most often numeric, whose values can be determined for a given combination of dimension members. For example, a value of the Sales measure may be determined for bicycles (i.e., a member of the Product dimension) in January (i.e., a member of the Month dimension).

Moreover, some enterprise software systems may utilize a product that lets a user to uncover and seize new opportunities anytime, anywhere and get instant answers to business questions (as well as take actions based on fast, decision-ready insights from any data source). The product may provide a business user with flexible, intuitive ad hoc reporting tools and interactive analytics via a desktop or mobile device. In addition, the product might help a user deliver personalized business intelligence to colleagues, customers, and partners. Such systems may, for example, improve productivity by giving users an intuitive tool for clearing Information Technology (“IT”) backlogs and improve ad hoc reporting and analytics across various data source with a flexible framework. Note that such a product might be associated with a web interface, a client/server deployment, or other environment.

A product may provide a simple to use tool for the production of reports with the help of a web browser. In some cases, the product may be easy to use and offer several efficient features. For example, different user groups may find it easy to use the application and to achieve rapid work results, without programming, including the production of formatted reports.

Note that the typical creation of a report may require some expertise at different levels of the reporting stack: defining the data source and the exact metadata to use to generate the report query; adding filters, prompts, and/or ranking to the query; creating variables to add extra metadata into the report micro-cube that contains the report data; defining how to display the data (chart or table properties, . . . ); and/or defining formats (colors, skins, fonts, etc.). Further note that all users are not necessarily trained on all these concepts and cannot become experts to all these concepts, especially when they have only some casual report creation needs. In other cases, users may have to create several different reports that may be quite similar and are based on similar definitions: same data source, same data provider, same look and feel (logo, format, etc.). In this case, recreating the elements again and again from scratch can become a tedious and repetitive task. A possible workaround is to copy an already known report. But this is still not a satisfying, optimized workflow, because when a change is required it must be propagated manually to all of the duplicated reports. It may also be desired to align reports with some pre-defined standard definitions (e.g., standard throughout a business enterprise) and automatically update these reports when these definitions are modified. Thus, approaches to provide improved report creation in a fast, simple and accurate manner may be desired.

### BRIEF DESCRIPTION OF THE DRAWINGS

FIG. 1 is a block diagram of a system according to some embodiments.

FIG. 2 is a flow diagram of a process according to some embodiments.

FIG. 3 illustrates relationships between shared elements documents according to some embodiments.

FIG. 4 is an example of a dependencies diagram according to some embodiments.

FIG. 5 illustrates linked and unlinked shared elements in accordance with some embodiments.

FIG. 6A is an example of a shared elements left pane display according to some embodiments.

FIG. 6B is an example of a browse pane display in accordance with some embodiments.

FIG. 7 is an example of a shared elements save dialog box display according to some embodiments.

FIG. 8 is an example of a shared elements search display according to some embodiments.

FIG. 9 is a block diagram of a computing device according to some embodiments.

FIG. 10 is a portion of a tabular representation of a shared elements database in accordance with some embodiments.

### DETAILED DESCRIPTION

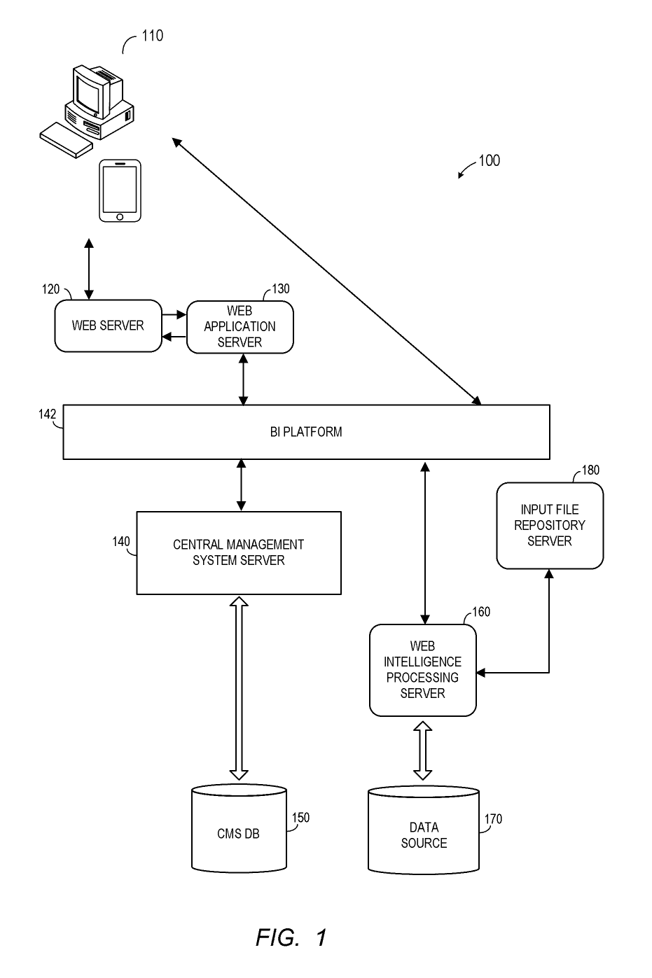

FIG. 1 is a block diagram of a system 100 according to some embodiments. FIG. 1 represents a logical architecture for describing processes according to some embodiments, and actual implementations may include more or different components arranged in other manners.

The system 100 includes client devices 110, such as Personal Computers (“PCs”), smartphones, etc. that may access a web application server 130 via a web server 120. The web application server may, according to some embodiments, access a Central Management System (“CMS”) database 150 via a Business Intelligence (“BI”) platform 142 and a CMS server 140. According to some embodiments, the web application server 130 may send a request for a document to a web intelligence processing server 160. The web intelligence processing server 160 retrieves the document from the input file repository server 180 and query data from a data source 170 to feed it with data. For example, the web intelligence processing server 160 may run a report engine that opens the document in memory and launch a connection server in processor. As a result, a Structured Query Language (“SQL”) or Multi-Dimensional eXpression (“MDX”) request may be generated (depending on the data source type), validated, and run to get the data from the data source 170 (relational, OLAP, text file, spreadsheet) to be processed by the report engine. The web intelligence processing server 160 may then send a viewable document page that was requested to the web application server 130 (to eventually be viewed via the client devices 110 via the web server 120 or direct access to the server). Note that the various elements described herein may support multi-tenancy to separately support multiple unrelated clients by providing multiple logical database systems which are programmatically isolated from one another.

The data in the data source 170 might be associated with a multi-dimensional database, an eXtendable Markup Language (“XML”) document, and/or any other structured data storage system. The physical tables of the system 100 may be distributed among several relational databases, multi-dimensional databases, and/or other data sources. For example, data source 170 may comprise one or more OnLine Analytical Processing (“OLAP”) databases (i.e., cubes). To provide economies of scale, the data source 170 may include data of more than one customer. In this scenario, the system 100 may include mechanisms to ensure that a client accesses only the data that the client is authorized to access. Moreover, the data of data source 170 may be indexed and/or selectively replicated in an index.

The data source 170 may implement an “in-memory” database, in which volatile (e.g., non-disk-based) storage (e.g., Random Access Memory (“RAM”)) is used both for cache memory and for storing data during operation, and persistent storage (e.g., one or more fixed disks) is used for offline persistency of data and for maintenance of database snapshots. Alternatively, volatile storage may be used as cache memory for storing recently-used database data, while persistent storage stores data. In some embodiments, the data comprises one or more of conventional tabular data, row-based data stored in row format, column-based data stored in columnar format, and object-based data.

The information in the data source 170 might be associated with an OLAP cube according to some embodiments. As described above, embodiments are not limited to OLAP technology or to three-dimensional datasets. The OLAP cube might store measure values corresponding to combinations of orthogonal dimension values. Specifically, for each combination of dimension values (e.g., Q1, Asia, Camera), the cube might store a value of the measure Sales and a value of the measure Profit. In other words, each measure value stored in the cube might be associated with a set of dimension values.

A dimension hierarchy may include dimensions arranged in a hierarchical format, in which each member of each of the dimensions is hierarchically related to members which lie above and below it in the hierarchy. For example, a cube might represent time by the dimension hierarchy Year>Half>Quarter, and region by the dimension hierarchy Hemisphere>Continent. In another example, geography may be represented by the dimension hierarchy: Continent>Country>State>City. In the former example, each member of the Half dimension may be hierarchically-related to a member of the Year dimension and to one or more members of the Quarter dimension.

According to some embodiments, an “automated” system 100 may facilitate the provision of information to clients. As used herein, the term “automated” may refer to, for example, actions that can be performed with little (or no) intervention by a human.

As used herein, devices, including those associated with the system 100 and any other device described herein may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

Although the system 100 has been described as a distributed system, note that the system 100 may be implemented in some embodiments by a single computing device. For example, both client devices 110 and CMS server 140 may be embodied by an application executed by a processor of a desktop computer, and the data source 170 may be embodied by a fixed disk drive within the desktop computer.

Although a single web application server 130 is shown in FIG. 1, any number of such devices may be included. Moreover, various devices described herein might be combined according to embodiments of the present invention. For example, in some embodiments, the web application server 130 and CMS server 140 might be co-located and/or may comprise a single apparatus.

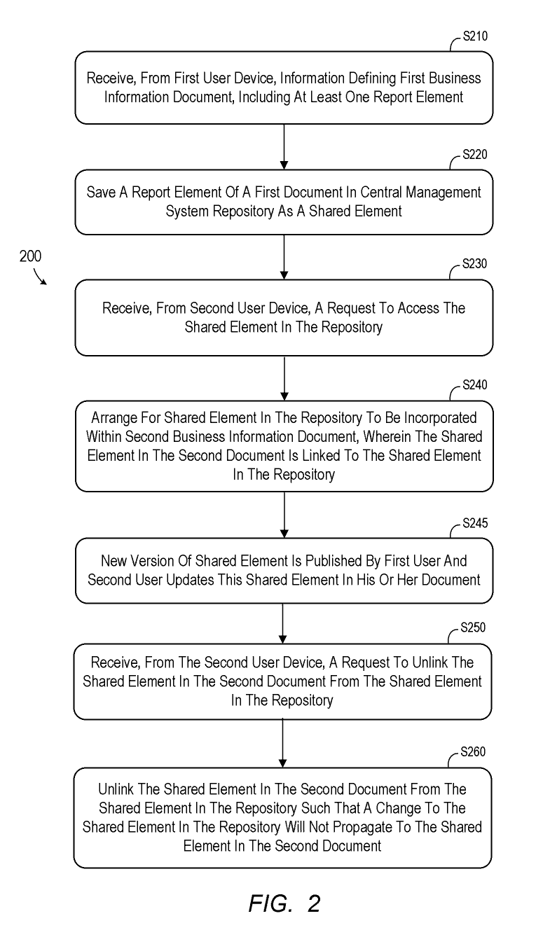

Note that the system 100 of FIG. 1 is provided only as an example, and embodiments may be associated with additional elements or components. According to some embodiments, the elements of the system facilitate an exchange of information to, from, and/or between clients or user. FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

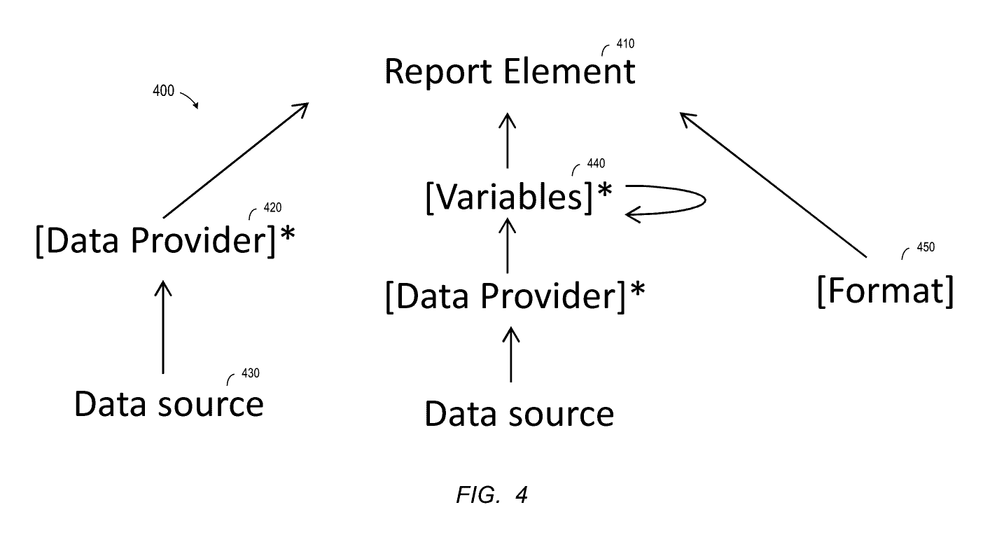

At S210, the system may receive, from a first user device associated with a first user, information defining a first business information document. The received information may include at least one report element. According to some embodiments, the received information may have a data provider and at least one variable (e.g., as described with respect to FIG. 4). The data provider might be associated with, for example, a query, including any of the data sources supported (such as the following non-exhaustive list): a universe, direct access to a business warehouse OLAP cube, a query to a web service, a text file, a spreadsheet application file or relational connection for a free-hand SQL query, etc. As used herein, the term “universe” may refer to a concept wherein a semantic layer is created on top of a data source. This semantic layer may hide technical concepts from an end user who does not know the identity of the underlying data source.

At S220, the system may save a report element from a first document in a CMS repository as a shared element. According to some embodiments, the shared element in the repository may include an indication of the data provider and an indication of at least one variable. Note that the shared element in the repository might further be associated with a property, a description, a type, a report filter, a report alert, and/or a report sort. According to some embodiments, the shared element in the repository further includes a type indicating a table, a chart, and/or a free cell. Note that the shared element in the repository could further include at least one data of the data source supported: a universe, a direct access to a business warehouse OLAP cube, a query to a web service, a text file, a spreadsheet application file, a relational connection for a free hand SQL query, etc. Moreover, the shared element in the repository might further include all of the properties related used to define the report element: a display type (chart, table, geographic map, etc.), a format value, a label, a color, a font, chart properties, etc.

At S230, the system may receive, from a second user device associated with a second user, a request to access the shared element in the repository and to add its content into a new report; which may simplify creation of the report. The system may then arrange, at S240 for the shared element in the repository (including, in some embodiments, the indication of the data provider and an indication of at least one variable) to be incorporated within a second business information document for the second user. According to some embodiments, the shared element in the second report document is linked to the shared element in the repository such that a change to the shared element in the repository may propagate to the shared element in the second document. Note that the request to access the shared element in the repository (received at S230) might be associated with a query to find the shared element from a set of potential shared elements in the repository. At S245, a new version of the shared element may be published by the first user and the second user may update this shared element in his or her document.

At S250, the system may receive, from the second user device, a request to unlink the shared element in the second document from the shared element in the repository. The system may then, at S260, unlink the shared element in the second document from the shared element in the repository such that a change to the shared element in the repository will not propagate to the shared element in the second document.

Thus, embodiments may deliver some substantial capabilities in order to simplify a user experience. These new features may let users: share content with other users; reuse content created by other users and trust this content when provided by experienced, “power” users; and/or factorize content to ease the update process. The shared elements may integrate smoothly in an existing framework, user interface, and/or workflows.

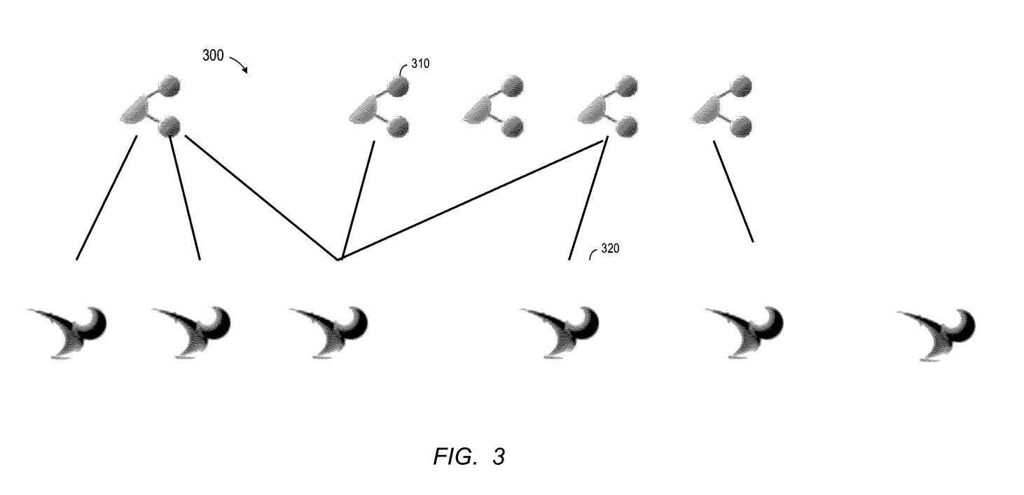

FIG. 3 illustrates relationships 300 between shared elements 310 and documents 320 that use these shared elements 310 according to some embodiments. The shared elements 310 described herein may let a user share content he or she has created in a CMS repository so that other users can reuse it quickly and easily. Users can share this content if they consider it useful, helpful, and/or complex and reusable. Such an approach may reduce the Total Cost of Ownership (“TCO”) since the content is created once and reused multiple times.

FIG. 4 is an example of a dependencies diagram 400 for a report element 410 according to some embodiments. The report element 410 may be associated with a data source 430 (e.g., via a data provider 420 and/or variables 440). According to some embodiments, any report element 410 from a document may be saved as a shared element. This report element 410 may be defined from (or linked to) other definitions contained in an interface, such as: the report element 410 itself and its properties: description, type . . . ; the variables 440 used by the report element 410, if any; the data providers 420 used by the report element 410 or its variables 440, if any (including the selected data provider 420 objects); data sources 430, if any; the format 450 defined for the report element 410 (labels, colors, chart and their properties), if any; and/or the dataset. For consistency, all of these definitions may be also saved in the shared element and added to the document as a whole when the shared element is inserted.

The shared element is created from the report element 410. The user can select one of the following report element types and save it as a shared element: a table; a chart; or a free cell. When the shared element is saved as a shared element, it is saved with its type, its definition and all its associated properties. Some report filters, alerts, and/or sorts may also be defined with the report element. They may also be saved in the shared element. If the report element 410 is a chart, then it may be possible to save a vignette of the chart in the shared element. This vignette might, for example, only be used in a user interface, so that the user can see a preview of the shared element before inserting it into the document.

A variable 440 is an object defined in the report through a formula given by the user. A variable 440 may be defined from one or several data provider objects 420. This allows a user to extend the document by adding these additional computations that enrich the document. When a report part is saved, the variables used by the report element 410 (and only these variables) may be saved in the shared element as well. The corresponding data providers (queries or custom data providers) from whom the variables are defined are saved in the shared element as well. If a shared element is copied in a document containing some variables, then the following algorithm may be used. When a variable from a shared element is inserted in a document: if a variable with the same name exists in the document; if the variables definition have the same tokenized form, then the copied shared element content uses the variable defined in the document; and if the variables definition have a different tokenized form, then the variable from the shared element is renamed (e.g., as MyVariable (2)) and replaced in the shared element content copied in the document. Otherwise, if a variable with the same token form definition exists in the document, then they may be merged, even when they have different names. The name of the variable of the document may be kept and replaced in the shared element content copied in the document.

According to some embodiments, there may be two data provider types: (1) the queries based on a universe which is a common interface that exposes a similar user friendly way to interact with and retrieve data from different data sources and (2) the custom data providers (text file, spreadsheet application file or a relational connection for a free-hand SQL query). Note that a data provider may be included in the shared element if it is used by the report element and/or a variable used by this report element.

If the report part is based on a query definition, the query (and its properties) may be saved in the shared element as well, including some or all of: a query name; a list of result objects; a list of sort objects; filters of query; query parameters (max rows . . . ); and/or parameters and contexts previous answers. When the shared element is inserted into a document, if the document contains a query based on the same data source and if they have the same query definition (the same objects, the same filters, etc.), then the queries may be considered as identical and the shared element can reuse the query from the document. This may avoid adding a new query in the document. A user may select to apply query stripping on the query saved in the shared element so only objects actually needed for the report element are saved in the shared element and not the whole query. For example, using query stripping can be useful if the report element is based only on a subset of the query. Note, however, that if several shared elements (that use different objects of the same query) are added into the same document, then this may create several queries in the document, instead of only one query used by all shared elements.

If a report is based on a custom data provider, then there may be no query definition to define the metadata to retrieve (but instead a list of objects from the data provider corresponding to the data source). When the shared element is inserted in a document, if the document contains a custom data provider based on the same data source and if they have the same selected objects, then the custom data providers might be considered identical and the shared element can reuse the custom data provider from the document.

According to some embodiments, any data source on which a report part can be created may be supported, such as: a universe; direct access (e.g., SAP BW OLAP connection or SAP HANA); a query to a web service; a custom data provider (e.g., a text file, a spreadsheet application file, or a relational connection for a free-hand SQL query, etc.). According to some embodiments, a data source (if any) is saved in the shared element. If the report part is based on several data sources, then all these data sources may be saved in the shared element. When the shared element is added to a document, the data source may be added in the list of document's data sources as well. If the data source was already used by the document, it might not be added, and the added shared element may use the existing data source.

If there is a format defined for the selected report element saved as a shared element, it may also be saved in the shared element. When the shared element is inserted in a document, the format saved with the shared element may apply (even when there is a style document defined). When creating the shared element, it might be possible to not save the format. In this case, when the shared element is inserted in the document, the document style would apply to the inserted shared element.

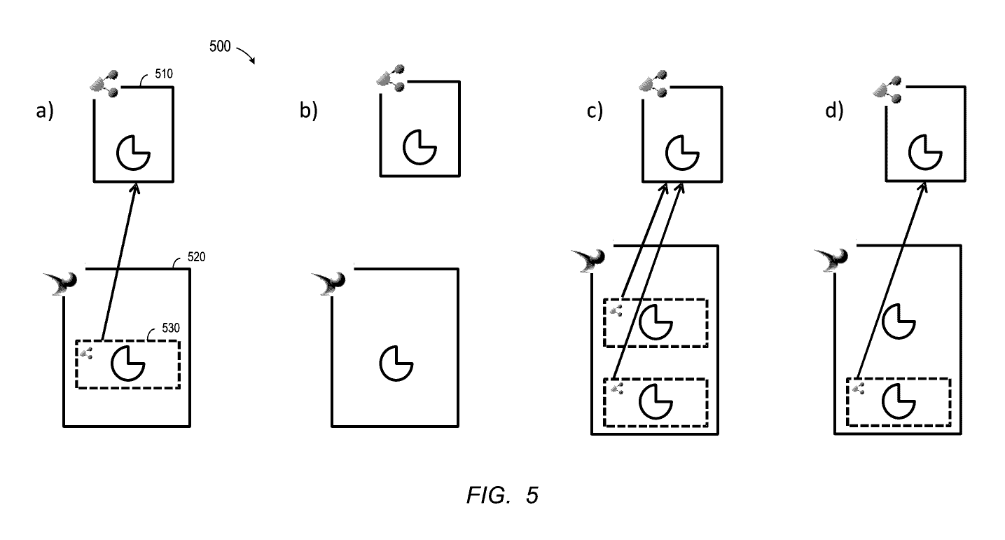

FIG. 5 illustrates 500 linked and unlinked shared elements 510 in documents 520 according to some embodiments. In particular the illustrations include: (a) a shared element 530 inserted into a document 520 and linked to its source shared element, (b) an unlinked shared element, (c) several instances of a shared element inserted into the same document, and (d) a linked and unlinked instance of a shared element in a document. When a shared element is inserted to a document, the shared element content (report element, query, data source, variable, format) may be added to the document. As the content is copied, it is processed as any content. A link to the source shared element may be kept. This link might only be kept to check for shared element updates. Removing this link simply unlinks the document from the shared element, but the shared element content remains in the document. If the data provider for this shared element is already available in the document, then the shared element content can be updated from the data saved in the cube for this data provider. Otherwise, when no data set is available for this shared element (e.g., data provider not yet used or data has been purged from the document), then the query is refreshed. Note that the same shared element can be inserted several times in the same document. Moreover, each instance of the inserted shared element may keep a link to the shared element in the CMS repository (which can be unlinked individually). A document can reference only one version of the same shared element. If it contains instances referencing previous versions of inserted shared element, then these instances must be updated when this new version is inserted.

When a shared element is inserted in the document, its content is explicitly copied in the document. The link between the shared element and the document is created, but because this is a copy (and not a dynamic reference), some differences may occur between the shared element in the CMS repository and its content copied in the document. Possible cases include: (i) in the CMS repository, another version of the shared element is available (e.g., a new version of the shared element has been published or a file has been restored and a previous version is now available in the CMS repository); and/or (ii) in the document, the user has done some changes to the shared element content (e.g., to the report element or any property attached to the report element, to the variable name or definition, to the format, to the data provider in connection with the query name, result objects, sort objects, to the data source and/or definition, and to the report element format). Note that both cases might happen for the same shared element.

A shared element may be inserted several times in the document, which creates different instances of the same shared document. For simplicity sake, only one version of the same shared element might be linked to a document. When an instance of a shared element is updated, this may update all associated instances. When a shared element is added, then all instances of this shared element with a different version may be updated as well, if it was already used. Note that an update may dismiss a report element change and report element format changes. Keeping a link with the shared element might mean that the shared element content is trusted. If the changes are to be kept, the user may: update the share object in the CMS repository; and unlink this copy of shared element in the document from the shared element in the CMS repository. When shared elements are updated, associated variables, data sources and/or data providers follow the copy and paste rules. They are not considered different from other variables, data sources or data providers already available in the document. They are either reused and updated or duplicated.

A shared element might be implemented as a generic container. This may open a wide range of options to implement new features and address new requirements. To store the shared elements in the CMS repository, a new InfoObject type called “Webi.SharedObject” may be introduced and be used generically for all shared elements' future needs. These shared elements can be saved in the CMS repository, in a public folder or the user's favorites folder. Concurrent publishing of the same object should not be a problem since it may be managed by the CMS. Note that there might be only one commit per save (so two publish event must be sequential, and the last one has the latest version). If the report element is a chart, then a vignette may also be saved in the InfoObject for preview in the user interface. The vignette may be, for example, a snapshot of the chart taken at publish time. It might be possible to know from a document the linked shared elements it uses. These links might be saved at two levels: (1) at InfoObject level (shared elements can be linked in the CMS repository through InfoObject links such that if one of the InfoObjects is deleted, then links may be removed t as well); and (2) in the document itself so it can be used by processing engines (the list of linked shared elements might be kept up to date when a shared element is inserted or removed from the document).

Note that when a document is saved, to update the InfoObjects links, it might not be necessary to parse the whole document to retrieve the linked shared elements. In the document, these links might also be available at two locations: (1) in a general “header,” to be used at save time and displayed in a Shared elements tab (e.g., to avoid parsing the whole document to update the InfoObjects links; and (2) associated with each report element coming from a linked shared element (it may be possible to right-click a report part coming from a shared element and call these commands: “Update shared element” to update all instances of the corresponding shared element and/or “Unlink shared element” to unlink this specific instance of the shared element). If the report element is deleted or unlinked from the shared element and if there is no more instance of the shared element in the document, the document is no longer linked to the shared element. The link is deleted when the document is saved. In the CMS repository, documents and shared elements may be linked through only a relationship type of “A document uses a shared element.” The link to the source document used to create a shared element may not be kept.

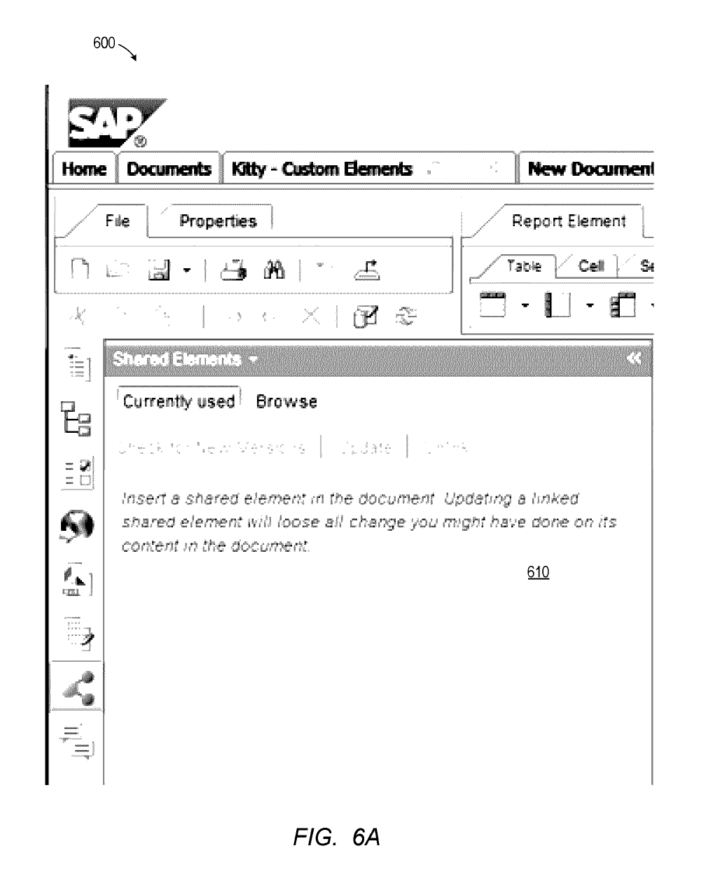

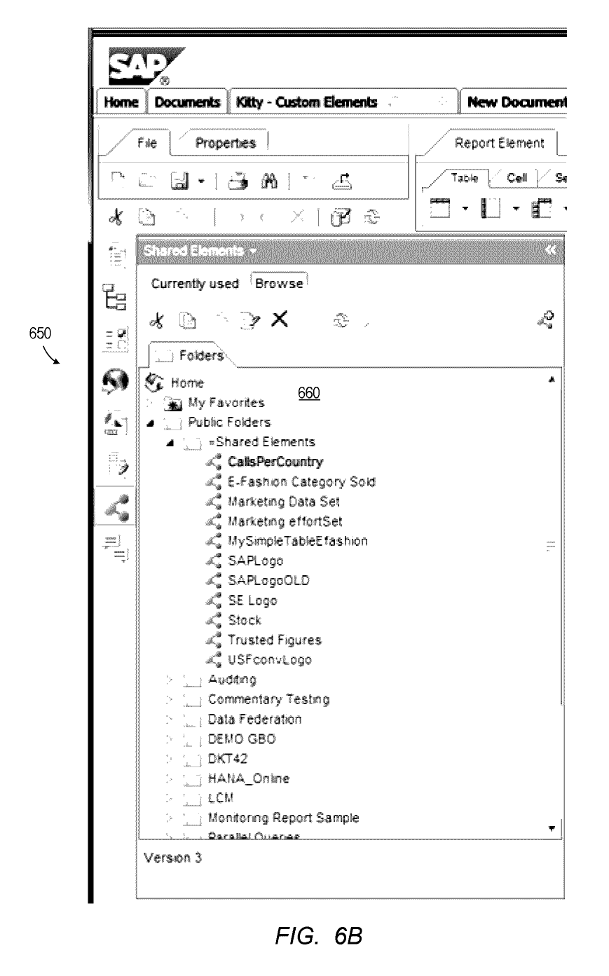

FIG. 6A is an example of a shared elements left pane display 600 including a linked shared elements pane 610 that contains the shared elements linked to the open document, including, for each shared element linked to the document: a name; a version of the instance inserted in the document; and/or an indication if the shared element in the CMS repository is missing, cannot be checked, and/or has another version. If no shared element is linked to the document, then a message may be displayed to help the user use shared elements. As illustrated in FIG. 6B, a browse pane 650 may let a user: navigate in the Public Folders and its Favorites folders and sub-folders; navigate in Categories; get a list of shared elements that have been saved in these folders he is allowed to see. According to some embodiments the pane 650 displays only objects, folders and categories the user is allowed to see. In the Folders tab 660, by default, only Favorites and Public Folders top root folders might be displayed. When the user clicks a folder, only the list of its direct children is retrieved from the CMS repository (e.g., lazy loading). If one of them is denied by security right, then it is not displayed. If both are denied, then a message is displayed and all icons in this pane are disabled.

According to some embodiments, the following workflows may be available and supported by all interfaces and deployments supported by the interface: web, client/server, mobile, standalone application, etc. To create a shared element, a user may connect to a CMS repository. He or she may be granted the “Shared elements: Enable creation” security right. (and the action must not have been hidden through customization). He or she can then select a report part from the document and select to save it as a shared element: in reading mode, he or can select the report element, right-click it and select a “Save as a shared element” command in the contextual menu; in design mode, he or she can select the report element, right-click it and select the a “Linking>Save as Shared element” command in the contextual menu; in reading mode, he or she can select the report element and click the “Share” button in the toolbar; and/or in design mode, he or can select the report element and click a “Save as a shared element” button in a “Report Element>Linking>Shared element” toolbar. These commands and buttons may be disabled if no report element or more than one report element is selected.

When the “Save as shared element” dialog box opens, the user can: give a name for the new shared element to save (by default “New shared element”); provide a description and some keywords for the new shared element; unselect a “Purge data” checkbox to save data with the shared element; select an “Apply query stripping” checkbox to apply query stripping when the query is saved; select a “Remove format” checkbox to not save the format attached to the report part; unselect a “Save preview” checkbox to not save a preview of the chart. If the report element is not a chart, then this checkbox is disabled and cannot be selected; navigate in the CMS repository Public Folders and Favorites folders to select the folder where the shared element must be saved; click “My Enterprise” to save the shared element in another CMS repository; assign some categories to the shared element in the Categories tab; and/or click “Save” to save the shared element. This dialog box may allow a user to display the shared elements already contained in the selected folder. The properties displayed for a shared element may include: a shared element name; a shared element version; a size of the shared element in the File Repository; the last modification date; the user that owns this shared element.

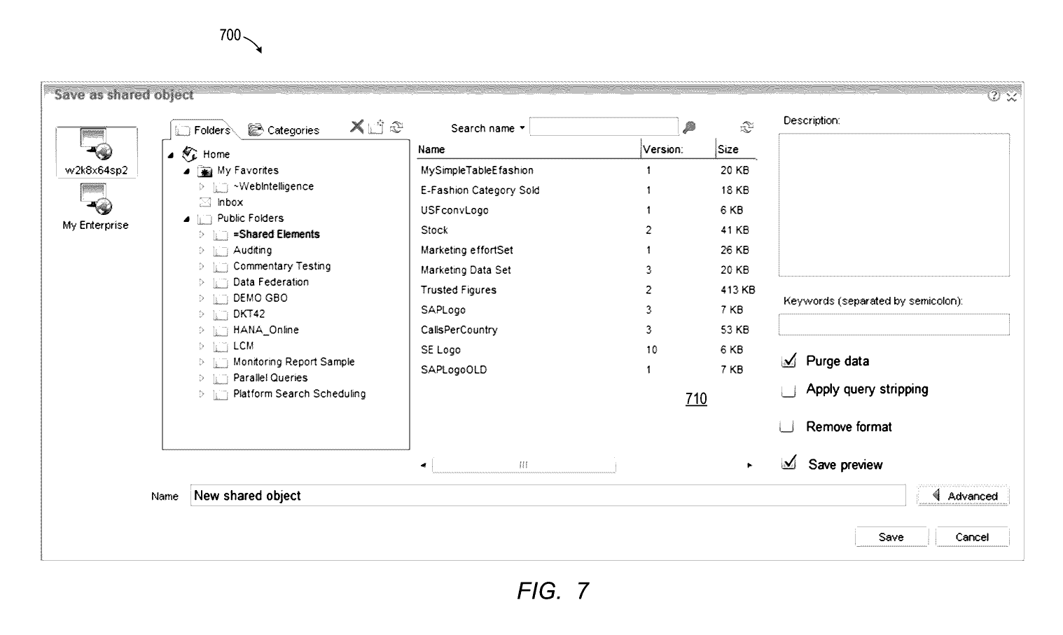

FIG. 7 is an example of a shared elements save dialog box display 700 including a name area 710 according to some embodiments. If a shared element with the same name already exists in the selected folder, then a warning message opens so the user can confirm that the shared element will be replaced. If the shared element is used by other documents, then the dialog box lists for information all the documents that use this shared element and that might be impacted by this shared element change. The user can confirm or cancel the action.

In the product interface, a shared element may be managed in browse pane in a Shared elements left panel. This pane may offer some basic administration capabilities, such as: create and delete sub-folder(s); move shared element(s) from one folder to another one; copy and paste one shared element; and/or delete shared element(s).

From browse pane, it may be possible to manage shared elements in the CMS repository and delete them. When a shared element is deleted from the CMS repository, then a popup window might display the impact analysis with the list of documents that are linked to this shared element (except the document source for the shared element). The window may request confirmation before actually deleting the shared element. If the user confirms, the shared element is deleted from the CMS repository. If the deleted shared element was used by the currently open document, then the Currently used pane may be updated to show that the shared element has been deleted.

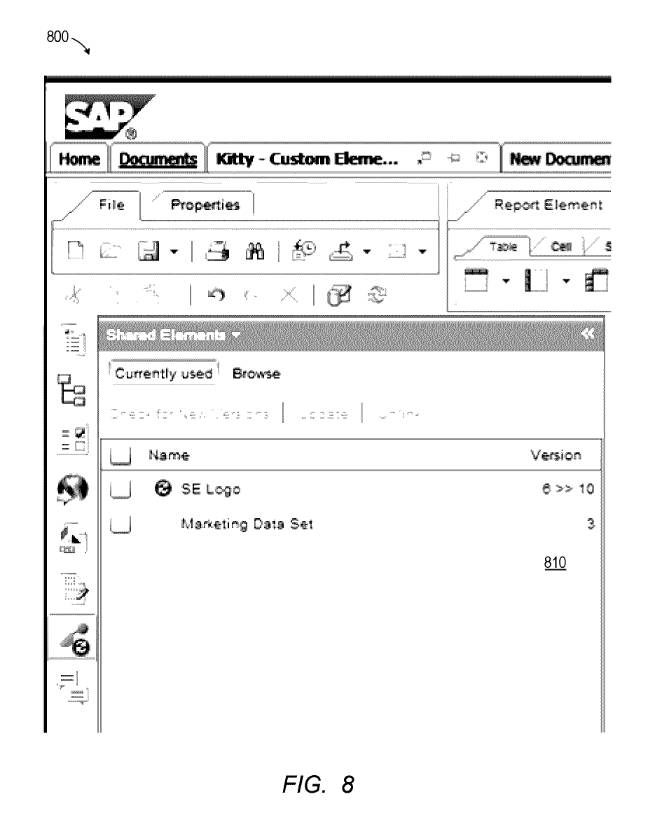

FIG. 8 is an example of a shared elements search display 800 including a name and folder area 810 according to some embodiments. In the browse pane, either in the design or reading mode, as long as the user is online and connected to the CMS repository, he or she may search for a specific shared element by clicking a magnifier icon. This icon might be enabled only if a folder (except the Home root folder) or a category has been selected. It may be disabled if the Home root folder, a shared element, and/or nothing has been selected. In a Search text field, the user can enter the search criteria. He or she can select for search shared elements through a name, a keyword, a description, and/or comments. The magnifying icon may be disabled if no text is entered in the text field. The names of the shared elements found by the search might then be displayed (e.g., with a full path). It may be possible to drag and drop into the report a shared element that has been found by such a search.

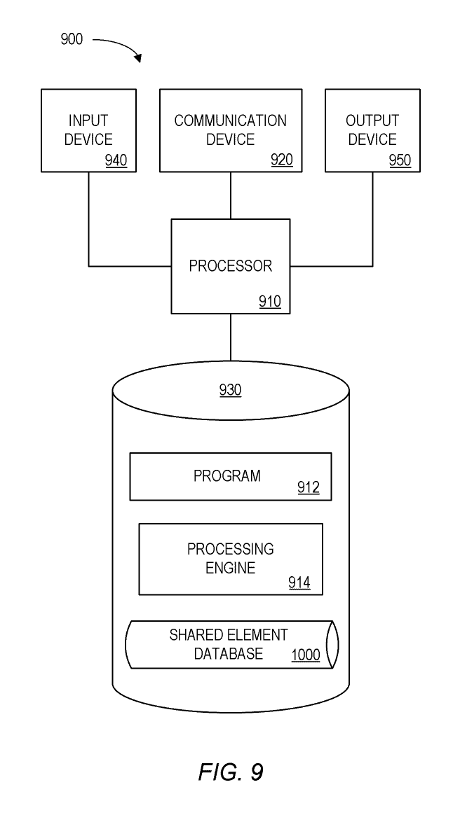

The embodiments described herein may be implemented using any number of different hardware configurations. For example, FIG. 9 illustrates a platform 900 that may be, for example, associated with the system 100 of FIG. 1. The platform 900 comprises a processor 910, such as one or more commercially available Central Processing Units (CPUs) in the form of one-chip microprocessors, coupled to a communication device 920 configured to communicate via a communication network (not shown in FIG. 9). The communication device 920 may be used to communicate, for example, with one or more remote client platforms. Note that communications exchanged via the communication device 920 may utilize security features, such as those between a public internet user and an internal network of a business enterprise. The security features might be associated with, for example, web servers, firewalls, and/or PCI infrastructure. The platform 900 further includes an input device 940 (e.g., a mouse and/or keyboard to enter information about shared elements) and an output device 950 (e.g., to output reports regarding system administration and/or business data).

The processor 910 also communicates with a storage device 930. The storage device 930 may comprise any appropriate information storage device, including combinations of magnetic storage devices (e.g., a hard disk drive), optical storage devices, mobile telephones, and/or semiconductor memory devices. The storage device 930 stores a program 912 and/or a processing engine or application 914 for controlling the processor 910. The processor 910 performs instructions of the programs 912, 914, and thereby operates in accordance with any of the embodiments described herein. For example, the processor 910 may arrange for information defining a first business information document, including a report element having a data provider and a variable, to be received from a first user's device. The first report document may be saved by the processor 910 in a CMS repository as a shared element, the shared element in the repository including an indication of the data provider and an indication of the variable. A request to access the shared element in the repository may then be received by the processor 910 from a second user's device. The shared element in the repository, including the indication of the data provider and the indication of the variable, are then incorporated by the processor 910 within a second report document for the second user. The shared element in the second report document may be linked to the shared element in the repository such that a change to the shared element in the repository propagates to the shared element in the second report document.

The programs 912, 914 may be stored in a compressed, uncompiled and/or encrypted format. The programs 912, 914 may furthermore include other program elements, such as an operating system, a database management system, and/or device drivers used by the processor 910 to interface with peripheral devices.

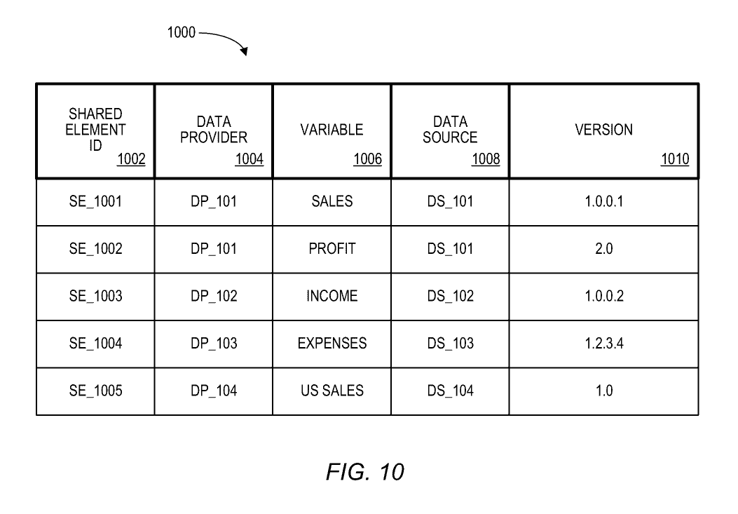

As used herein, information may be “received” by or “transmitted” to, for example: (i) the platform 900 from another device; or (ii) a software application or module within the platform 900 from another software application, module, or any other source. In some embodiments (such as shown in FIG. 9), the storage device 930 includes a shared element database 1000. An example of a database that may be used in connection with the platform 900 will now be described in detail with respect to FIG. 10. Note that the databases described herein are only examples, and additional and/or different information may be stored therein. Moreover, various databases might be split or combined in accordance with any of the embodiments described herein. For example, the shared element database 1000 might be combined and/or linked to each other within the processing engine 914.

Referring to FIG. 10, a table is shown that represents the shared element database 1000 that may be stored at the platform 900 according to some embodiments. The table may include, for example, entries identifying shared elements that may be inserted into documents. The table may also define fields 1002, 1004, 1006, 1008, 1010 for each of the entries. The fields 1002, 1004, 1006, 1008, 1010 may, according to some embodiments, specify: a shared element identifier 1002, a data provider 1004, a variable 1006, a data source 1008, and a version 1010. The shared element database 1000 may be created and updated, for example, based on information electrically received from a power user of a business enterprise.

The shared element identifier 1002 may be, for example, a unique alphanumeric code identifying a shared element that might be inserted into a document. The data provider 1004, variable 1006, and/or data source 1008 might define how information about the shared element is to be obtained. The version 1010 might indicate a software version of the shared element (and when the version is updated, multiple shared elements in multiple documents might be automatically refreshed).

In this way, embodiments may support a generic new concept for an interface called shared elements or objects. A user can create a shared element from an interface report and save it in a business information repository for reuse by other users. The shared element may be sufficient by itself, meaning it is generated with all the details required to add it and use it in another document, including: a report part (chart, table, array) and its properties to be displayed; and semantic layer details, such as a connection, universe, data provider, metadata dictionaries, format, and/or variables. The shared element might have been added by other users from new or already existing reports. When inserting a shared element in an existing report, the system may be smart enough to: merge/similar components from the shared element and the document; and re-create missing metadata in the target document. Once a shared element is inserted in a report, the report may become linked to this shared element. As a result, it may be possible to track any updates that may have been done on the shared elements a document uses, such as: a new version of a shared element has been published; or a previous version of a shared element has been restored.

As long as the document remains linked to some shared elements published by power users, the users can trust this document and check that it still uses the latest version of these shared elements. Embodiments may also provide a lower TCO since less time may be needed to create content and/or content creation can be delegated to a few expert users. Moreover, all created content may be consistent with some predefined shared element, and the shared element is agnostic to the data source used by the report: a universe, direct connectivity, a personal or shared file, etc. When a shared element is added to an existing document, it may take into consideration the document's existing content to reuse it instead of recreating it. Depending on the document context, each report element definition is reviewed and two cases may happen: (1) it may be merged with the corresponding document definition, or (2) it may be kept by the report definition. Embodiments may also utilize semantic layer concept used to create the report element (data source definition or connection, universe metadata). When a shared element definition is modified, it may benefit all documents that use it, without having to perform the same changes in all documents using it. The data contained in a report can also be added to the shared element. Hence, the shared element may contain both metadata and data. The shared element might not contain only metadata definition but also include information to share. The shared elements can be a format pivot for sharing content with other business information tools hosted in a business in formation platform. This may favor interoperability between various reporting tools.

The embodiments described herein are solely for the purpose of illustration. Those in the art will recognize other embodiments may be practiced with modifications and alterations limited only by the claims.

What is claimed is:

1. A method implemented by a computing system in response to execution of program code by a processor of the computing system, the method comprising:
receiving, from a first user device associated with a first user, information defining a first business information document, including at least one report element having a data provider and at least one variable; and
saving a report element of a first report document in a central management system repository as a shared element, the shared element in the repository including an indication of the data provider and an indication of at least one variable.

2. The method of claim 1, wherein the data provider comprises at least one of: (i) a query, (ii) a custom data provider, a text file, a spreadsheet application, or a free-hand SQL query.

3. The method of claim 1, wherein the shared element in the repository further includes at least one of: (i) a property, (ii) a description, (iii) a type, (iv) a report filter, (v) a report alert, and (vi) a report sort.

4. The method of claim 3, wherein the shared element in the repository further includes a type indicating at least one of: (i) a table, (ii) a chart, and (iii) a free cell.

5. The method of claim 4, wherein the shared element in the repository further includes at least one data source associated with at least one of: (i) a universe, (ii) a direct access business warehouse On-Line Analytical Processing cube, (iii) a query to a web service, (iv) a text file, (v) a spreadsheet application file, and (vi) a relational connection for a free hand SQL query.

6. The method of claim 5, wherein the shared element in the repository further includes at least one of: (i) a format value, (ii) a label, (iii) a color, and (iv) a chart property.

7. The method of claim 1, further comprising:
receiving, from a second user device associated with a second user, a request to access the shared element in the repository; and
arranging for the shared element in the repository, including the indication of the data provider and the indication of the at least one variable, to be incorporated within a second business information document for the second user,
wherein the shared element in the second document is linked to the shared element in the repository such that a change to the shared element in the repository may propagate to the shared element in the second document.

8. The method of claim 7, further comprising:
receiving, from the second user device, a request to unlink the shared element in the second document from the shared element in the repository; and
unlinking the shared element in the second document from the shared element in the repository such that a change to the shared element in the repository will not propagate to the shared element in the second document.

9. The method of claim 7, wherein the request to access the shared element in the repository is associated with a query to find the shared element from a set of potential shared elements in the repository.

10. A non-transitory medium storing processor-executable program code, the program code executable by a processor of a computing device to:
receiving, from a first user device associated with a first user, information defining a first business information document, including at least one report element having a data provider and at least one variable; and
saving the first document in a central management system repository as a shared element, the shared element in the repository including an indication of the data provider and an indication of the at least one variable.

11. The medium of claim 10, wherein the data provider comprises at least one of: (i) a query, (ii) a custom data provider, a text file, a spreadsheet application, or a free-hand SQL query.

12. The medium of claim 10, wherein the shared element in the repository further includes at least one of: (i) a property, (ii) a description, (iii) a type, (iv) a report filter, (v) a report alert, and (vi) a report sort.

13. The medium of claim 12, wherein the shared element in the repository further includes a type indicating at least one of: (i) a table, (ii) a chart, and (iii) a free cell.

14. The medium of claim 13, wherein the shared element in the repository further includes at least one data source associated with at least one of: (i) a universe, (ii) a direct access business warehouse On-Line Analytical Processing cube, (iii) a query to a web service, (iv) a text file, (v) a spreadsheet application file, and (vi) a relational connection for a free hand SQL query.

15. The medium of claim 11, further comprising:
receiving, from a second user device associated with a second user, a request to access the shared element in the repository; and
arranging for the shared element in the repository, including the indication of the data provider and the indication of the at least one variable, to be incorporated within a second business information document for the second user,
wherein the shared element in the second document is linked to the shared element in the repository such that a change to the shared element in the repository may propagate to the shared element in the second document.

16. The medium of claim 15, further comprising:
receiving, from the second user device, a request to unlink the shared element in the second document from the shared element in the repository; and
unlinking the shared element in the second document from the shared element in the repository such that a change to the shared element in the repository will not propagate to the shared element in the second document.

17. A system comprising:
a memory storing processor-executable program code; and
a processor to execute the processor-executable program code in order to cause the computing device to:
receive, from a first user device associated with a first user, information defining a first business information document, including at least one report element having a data provider and at least one variable, and
save the first report document in a central management system repository as a shared element, the shared element in the repository including an indication of the data provider and an indication of the at least one variable.

18. The system of claim 17, wherein the data provider comprises at least one of: (i) a query, and (ii) a custom data provider (a text file, a spreadsheet application, or a free-hand SQL query).

19. The system of claim 17, wherein the shared element in the repository further includes at least one of: (i) a property, (ii) a description, (iii) a type, (iv) a report filter, (v) a report alert, and (vi) a report sort.

20. The system of claim 17, wherein the processor-executable program code will further cause the computing device to:
receive, from a second user device associated with a second user, a request to access the shared element in the repository, and
arrange for the shared element in the repository, including the indication of the data provider and the indication of the at least one variable, to be incorporated within a second business information document for the second user,
wherein the shared element in the second document is linked to the shared element in the repository such that a change to the shared element in the repository may propagate to the shared element in the second document.

21. The system of claim 20, wherein the processor-executable program code will further cause the computing device to:
receive, from the second user device, a request to unlink the shared element in the second document from the shared element in the repository, and
unlink the shared element in the second report document from the shared element in the repository such that a change to the shared element in the repository will not propagate to the shared element in the second document.
